(19) United States
(12) Patent Application Publication
(10) Pub. No.: US 2011/0120408 A1
(43) Pub. Date: May 26, 2011

(54) Internal surface heat dissipation oil pan

(76) Inventor: Brian Reese, Collierville, TN (US)

(21) Appl. No.: 12/591,508

(22) Filed: Nov. 20, 2009

(51) Int. Cl. F01M 11/00; F16H 57/04

(52) U.S. Cl. 123/195 C; 74/606 A

(57) ABSTRACT

Variations of a device for collecting viscous fluid from a fluid containing device. Variations include features that protrude into an interior portion and/or from an exterior portion of the device and maximize the surface area of the device exposed to the collected fluid, to enhance cooling and for other purposes. Other variations include both interior and exterior fins or other features as well as convex, concave or bowed side walls. Further, various aspects of the device may be divided into sections arranged to increase the overall surface area of the device exposed to the collected fluid, to enhance cooling and for other purposes. Methods for using the device are also disclosed, including a method that uses the features to cool the collected viscous fluid.

### BACKGROUND OF THE INVENTION

1. Field of the Invention

Aspects of the present invention relate to viscous fluid collection devices and particularly to viscous fluid collection devices for collecting and cooling hot or heated viscous fluid, such as oil for an internal combustion engine, fluid from a transmission, valve system or other combustion engine or related device having a coolable viscous fluid, such as in high performance or heavy duty applications. Aspects of the present invention also relate to viscous fluid collection devices in general, and in particular those for radiating or conducting heat away from a collected fluid.

2. Background of the Related Art

Related art viscous fluid collection devices for collecting viscous fluid from engines or other fluid containing devices may include, for example, automobile engines, which usually include oil pans at the bottom of engines. Oil distributed over the crank shaft and/or other components collects in the oil pan under the force of gravity. The oil is then re-circulated using a sump pump or other fluid recirculation mechanism, so that the oil can be reused by the engine for lubrication and/or cooling. It is generally advantageous to avoid denaturing or “break down” of oil as long as possible in this process, so that the parts of the engine can be most effectively lubricated by the re-circulating oil as long as possible.

One of the main causes of oil break down is the high temperatures to which the oil is subjected in a functioning engine. The crank shaft and other engine components are typically thermally coupled to the main heat sources of the engine and, therefore, heat the oil to temperatures close to the operating temperature of the engine. If the temperature of the oil rises above a “break down point,” at which the heat causes chemical denaturing of the oil, the oil may lose some of its lubricating properties. Thermal “break down” of the engine oil may also cause other problems, such as clogging due to the accumulation of waste products or denatured oil in the engine. Such events can also affect properties of the oil, such as viscosity, in ways that alter or degrade the functioning of engine or other components. In some cases, for example, denaturing of the oil can cause problems with sump pumps or fluid recirculation devices, which may be calibrated to pump oil having certain properties (e.g., limited viscosity range) more effectively. The very temperature of the oil itself may be a problem for some pumps or fluid recirculation devices. Other potential problems caused by de-natured oil may include scored pistons, ring damage, and/or general over-heating of the engine. Since over-heating of the engine may cause damage to a variety of components, especially those involving relatively delicate flanges, seals, or portions of the engine where two materials with differing thermal coefficients of expansion meet, this condition typically results in damage to the engine. As a result, over-heating often leads to additional required maintenance and/or part replacements.

Therefore, there is a need in the art for a viscous fluid collection device for use in engines or other fluid containing devices that can avoid these problems by dissipating heat in the collected fluid more effectively. There is also a need in the art for a viscous fluid collection device that can store and effectively cool a greater amount of collected fluid. In addition, there is a need in the art for a viscous fluid collection device or collecting device that is relatively cost effective and easy to manufacture.

### SUMMARY OF THE INVENTION

While the discussion of the aspects of the present invention that follows uses collecting fluid from an engine for an illustrative purpose, it should be appreciated that such aspects are not limited to this application. Aspects of the invention may be used in a variety of other environments. For example, aspects of the present invention may be used in fluid extraction applications relating to manufacturing, construction, assembly lines, handling and disposing of hazardous materials, underwater manipulations, handling of high temperature materials, or any other suitable environment where a user may need to extract or otherwise handle viscous fluid.

Among other things, aspects of the present invention may aid in the collection and cooling of fluid from an engine or other fluid containing device. For example, in some variations features on the interior and/or exterior of a viscous fluid collection device, in accordance with aspects of the present invention, increase the surface area of the viscous fluid collection device thermal device in contact with the fluid. The features may protrude from one or more of the interior and/or exterior surfaces of the fluid containing device. Additional aspects of the present invention may include a method for cooling a collected viscous fluid from an engine or other fluid containing device using a fluid containing device with increased interior and/or exterior surface area.

One aspect of the present invention comprises: a viscous fluid collection device for collecting viscous fluid, including: an interior cavity where the fluid is collected; a bottom cavity surface, having an exterior facing side and an interior cavity facing side, wherein viscous fluid is collected on the interior cavity facing side; one or more side portions contiguous with the bottom cavity surface, each of the side portions having an exterior facing side and an interior cavity facing side; a flange connected to at least one of the side portions for closeably attaching the cavity of the viscous fluid collection device; and interior or exterior features on at least one of the bottom cavity surface or one of the one or more side portions that increase surface area for the fluid collecting device in communication with collected fluid, the interior or exterior features being configured so as to increase heat dissipation and so as to be in thermal communication with the collected fluid.

In another aspect of the present invention, a viscous fluid collection device for collecting viscous fluid, includes: an interior cavity where the fluid is collected; a bottom cavity surface, having an exterior facing side and an interior cavity facing side; a pattern of features on the interior or exterior side of the bottom cavity surface, wherein the features in the pattern protrude into the interior or exterior of the viscous fluid collection device from the interior or exterior side of the bottom cavity surface and increase surface area for the fluid collecting device contacting collected fluid, the interior or exterior features being located so that they are thereby in thermal communication with the collected fluid; one or more side portions on the bottom cavity surface, each of the side portions having an exterior facing side and an interior cavity facing side; and a flange connected to at least one of the side portions for closeably attaching the cavity of the viscous fluid collection device.

In yet another aspect of the invention, a method of collecting viscous fluid in a device includes: collecting the viscous fluid in an interior cavity of a viscous fluid collection device; and exposing the collected viscous fluid to features protruding from interior walls of the viscous fluid collection device that increase an interior and/or exterior surface area of the viscous fluid collection device, thereby conducting heat away from the collected fluid through the features.

Aspects of the present invention provide, among other things, benefits and advantages that include an increased ability to cool a collected fluid. Further, aspects of the present invention provide benefits in terms of the ease of manufacture of a device used to collect and cool fluid from another device.

Additional advantages and novel features relating to aspects of the present invention will be set forth in part in the description that follows, and in part will become more apparent to those skilled in the art upon examination of the following or upon learning by practice certain aspects thereof.

### BRIEF DESCRIPTION OF THE DRAWINGS

Aspects of the present invention will become fully understood from the detailed description given herein below and the accompanying drawings, which are given by way of illustration and example only and thus not limited with respect thereto, wherein:

FIG. 1A is an overview of an exemplary viscous fluid collection device according to aspects of the present invention;

FIG. 1B is a cross-sectional representative view of part of the exemplary viscous fluid collection device of FIG. 1A;

FIGS. 1C-1E present representative side profile views of parts variations of the exemplary viscous fluid collection devices of FIG. 1A, in accordance with aspects of the present invention;

FIG. 2 is a close-up view of the bottom cavity surface of the exemplary viscous fluid collection device of FIG. 1A;

FIG. 3 is another close-up view of the bottom cavity surface of the exemplary viscous fluid collection device of FIG. 1A;

FIG. 4 is another close-up view of the bottom cavity surface of the exemplary viscous fluid collection device of FIG. 1A; and

FIG. 5 is another close-up view of the bottom cavity surface of the exemplary viscous fluid collection device of FIG. 1A highlighting an exemplary hexagonal pattern of features.

### DETAILED DESCRIPTION

Aspects of the present invention will now be described more fully hereinafter with reference to the accompanying drawings, in which variations and illustrations of features of the present invention are shown. Aspects of the present invention may, however, be realized in many different forms and should not be construed as limited to the variations set forth herein; rather, the variations are provided so that this disclosure will be thorough and complete in the illustrative implementations, and will fully convey the scope thereof to those skilled in the art.

Unless otherwise defined, all technical and scientific terms used herein have the same meaning as commonly understood by one of ordinary skill in the art to which aspects of the present invention belong. The methods and examples provided herein are illustrative only and not intended to be limiting.

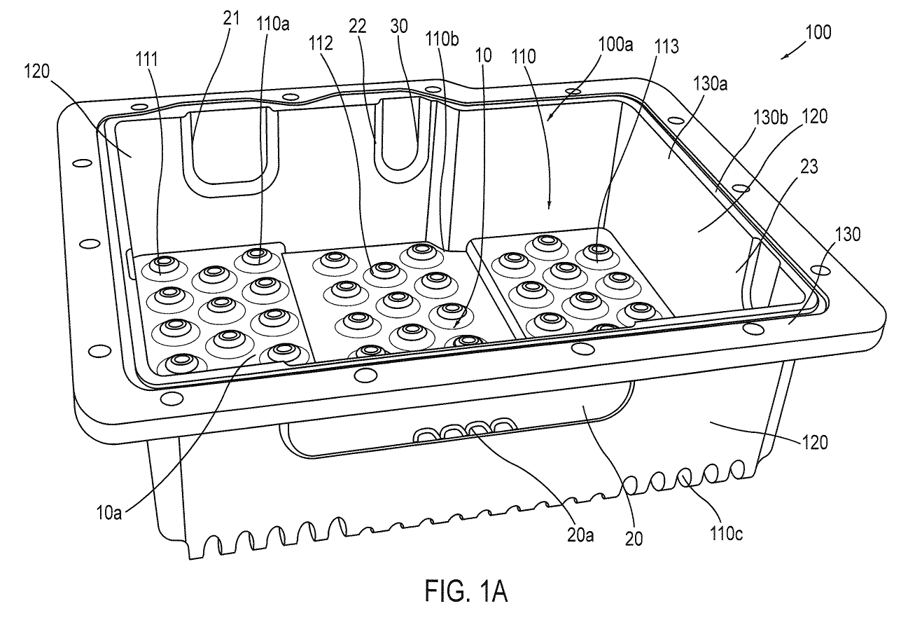

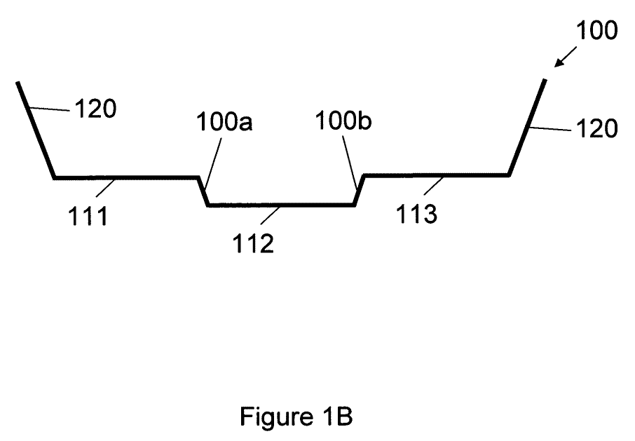

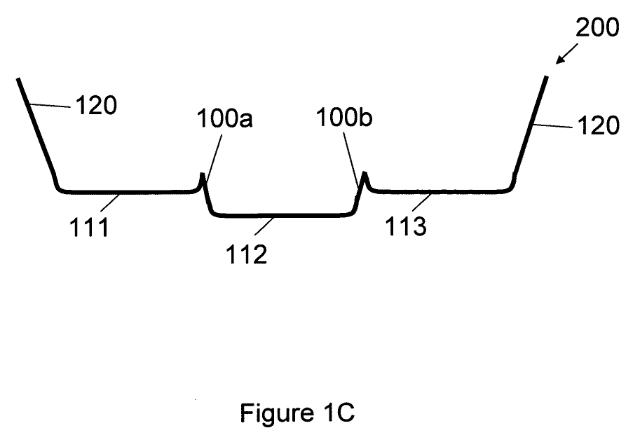

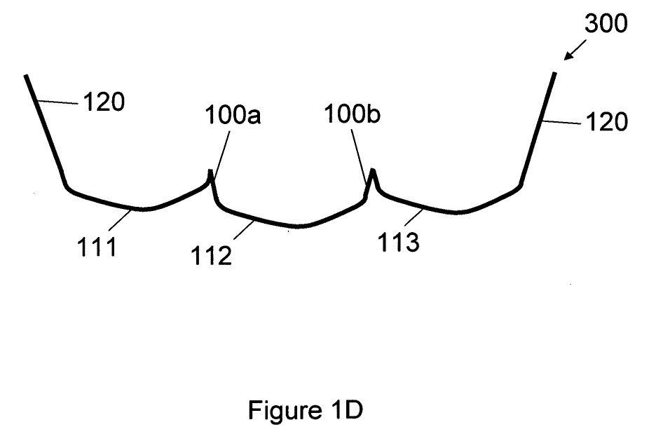

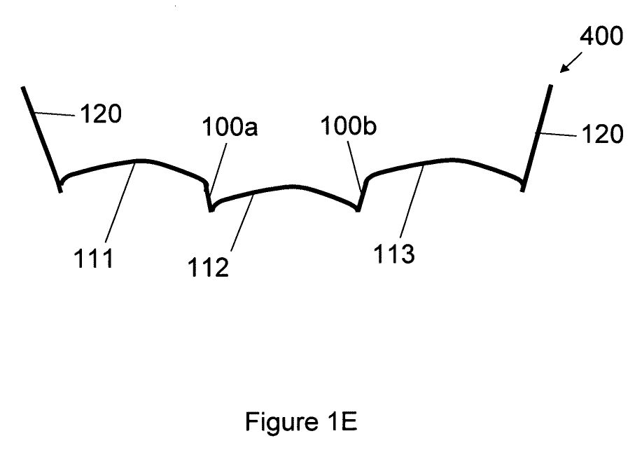

FIG. 1A is an overview of an exemplary viscous fluid collection device according to aspects of the present invention. As shown in FIG. 1A, the exemplary viscous fluid collection device 100 may have a portion 110, side portions 120 and a flange 130. FIG. 1B is a cross-sectional representative view of part of the exemplary viscous fluid collection device of FIG. 1A. FIGS. 1C-1E present representative side profile views of parts variations of the exemplary viscous fluid collection devices of FIG. 1A, in accordance with aspects of the present invention.

The exemplary viscous fluid collection device 100 shown in FIG. 1A, for example, may have a generally rectangular cross-sectional shape (e.g., viewed from above as shown in FIG. 1A) or it may have any other suitable alternative shape. For example, the exemplary viscous fluid collection device 100 of FIG. 1A may have the shape of a rounded cylindrical trough, or it may have sides that meet each other at angles other than approximately right angles as shown in FIG. 1A. The exemplary viscous fluid collection device 100 of FIG. 1A may also be shaped and/or sized to fit a particular engine or other fluid using device, or the exemplary viscous fluid collection device 100 may be shaped and/or sized to fit around other components attached to such devices, for example. The exemplary viscous fluid collection device 100 may have still other suitable shapes, or other features, including shapes that maximize the ratio of surface area of the exemplary viscous fluid collection device 100 to its volume, and vice versa. Portions of exemplary viscous fluid collection device 100 may incorporate any suitable material of construction. For example, the exemplary viscous fluid collection device 100 may comprise an especially thermally conductive material, such as a metal, metal alloy, or composite material, which may include fibers or other aspects that aid in the conduction of heat or thermal energy away from viscous fluid contained in the collection device 100. The exemplary viscous fluid collection device 100 may also have portions that include polymer, ceramic, composite material or suitable combinations thereof.

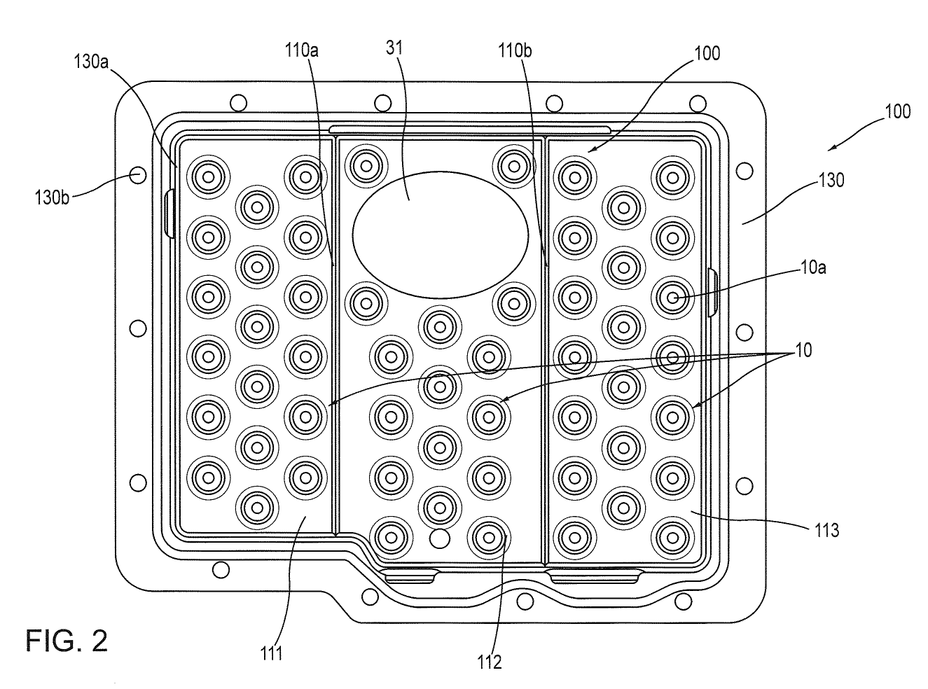

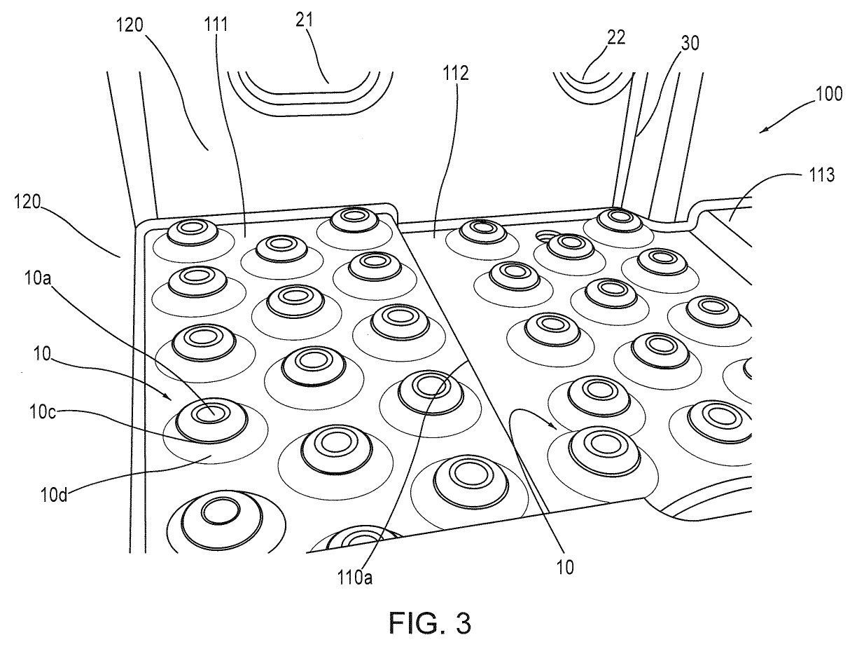

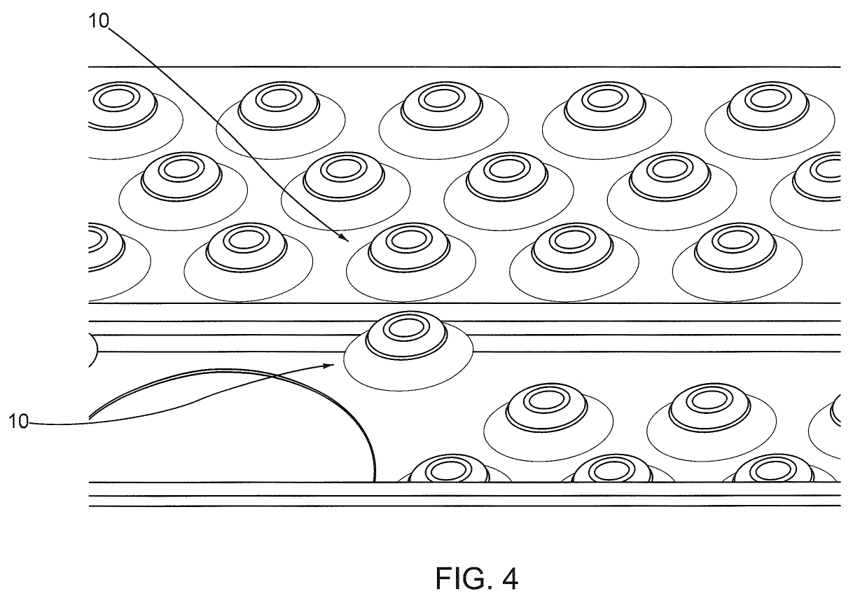

FIG. 2 is a close-up view of the bottom cavity surface of the exemplary viscous fluid collection device of FIG. 1A. FIGS. 3 and 4 show other close-up views of portions of the bottom cavity surface of the exemplary viscous fluid collection device of FIG. 1A.

As shown in FIG. 2, the portion 110 may be divided into sections 111-112. In principle, any suitable number of sections 111-112 is possible, though FIG. 2 shows, for illustrative purposes only, three such sections. The sections 111-112 may, for example, be staggered or stepped, as shown in FIGS. 1A and 1B. A staggered configuration of sections 111-112 may, for example, allow for an increased overall surface area of the exemplary viscous fluid collection device 100, particularly of its portion 110, as shown in FIG. 1A. For example, one of the sections 111-112 may be lower than others, as shown in FIG. 1A, or stepped, such that the overall surface area of the portion 110 is increased (e.g., via surface area of partitions 100a and 100b, as shown in FIG. 1b). The sections 111-112 need not all be co-planar, as shown in FIGS. 1A, 1B and 2, and may be set at angles with one another, for example, in order to increase the surface area of the portion 110 of the exemplary viscous fluid collection device 100. Connecting walls 110a and 110b may distinguish each of the sections 111-113. The sections 111-113 may also have generally convex or other overall shapes in order to, among other things, increase the surface area of the portion 110. The connecting walls 110a and 110b may be sloped in order to, among other things, increase the surface area of the bottom 110 of the exemplary viscous fluid collection device 100.

As shown in FIG. 1A, the portion 110 of the exemplary viscous fluid collection device 100 may also include one or more exterior ridges or fins 110c. The exterior ridges or fins 110c may serve a variety of functions, including providing greater surface area for the exemplary viscous fluid collection device 100 exposed to air or other cooling medium in order to, among other things, increase heat dissipation. In addition, the exterior ridges or fins 110c may also maintain frictional contact with a surface when the exemplary viscous fluid collection device 100 is removed from an engine or other fluid using device and placed on that surface. The increased frictional contact provided by the exterior ridges or fins 110c may, for example, prevent lateral sliding of the exemplary viscous fluid collection device 100 during servicing. The exterior ridges or fins 110c may include metal, ceramic, polymer, composite materials or any suitable combination thereof for dissipating heat from the exemplary viscous fluid collection device 100. The exterior ridges or fins 110c may include branched, capillary containing features and/or other structures to aid in heat dissipation. The exterior ridges or fins 110c may further comprise gripping or high friction material, including rubber pads or patterned or grooved plastic. In addition, the exterior ridges or fins 110c may allow for enhanced ventilation actively to further cool the portion 110 of the exemplary viscous fluid collection device 100 as fluid is collected.

For example, if the exemplary viscous fluid collection device 100 is mounted to an engine block on a vehicle, the exterior ridges or fins 110c may direct airflow (e.g., from passing air when the vehicle is in motion) in and around the bottom surface of the exemplary viscous fluid collection device 100 to cool it efficiently. Air or other cooling medium flow may also be assisted using various other air circulating devices, including fans. In addition, liquid coolant may be provided around or through the exterior ridges or fins 110c, for example, in order to, among other things, cool the portion 110 of the exemplary viscous fluid collection device 100 as fluid is collected.

The portion 110 of the exemplary viscous fluid collection device 100 may include other interior or exterior features 10 or other aspects that can increase the overall surface area of the portion 110. As shown in FIGS. 2 and 4, the interior or exterior features 10 may have the shape of a circular cone, for example. However, it is to be understood that the interior or exterior features 10 may take any suitable shape and may be integral to the surface 110 or may be attached, bolted, welded, bonded or fixed to the surface 110 in any suitable way such that there is a thermally conductive path between the feature 10 and the surface 110. For example, interior or exterior features 10 may take the shape of a pointed cone, various pyramid shapes, a spherical shape or have shapes that are combinations thereof. Still other shapes are possible. For example, the interior or exterior features 10 may have cross-sections that are T-shaped or L-shaped. The interior or exterior features 10 may be fin-shaped, block-shaped, pin-shaped or grid-shaped. The interior or exterior features 10 need not be solid and may have any suitable number of holes, depressions or other suitable features for enhancing cooling action and/or reducing weight. The interior or exterior features 10 need not all have the same shape. For example, it may be advantageous in some applications for the interior or exterior features 10 to be differently shaped in different sections of the portion 110 or to have another suitable pattern of shapes. As shown in FIG. 1A, the interior or exterior features 10 may be convex relative to the contained fluid and point into the interior 100a of the exemplary viscous fluid collection device 100. Alternatively, the interior or exterior features 10 may be concave relative to the contained fluid and point outwardly from the interior 100a of the exemplary viscous fluid collection device 100. In still another alternative, the interior or exterior features 10 may have both concave and convex portions. In addition, in some variations, some of the interior or exterior features 10 may be concave and others convex.

As shown in FIGS. 3 and 4, in one exemplary configuration, the features 10 or other aspects may include troughs 10a that further increase surface area of the bottom cavity surface 100 of the exemplary viscous fluid collection device 100. Increasing the surface area of the portion 110 of the exemplary viscous fluid collection device 100 may enhance cooling of collected fluid by increasing the surface area to volume ratio of collected fluid. This effect may be enhanced when the portion 110 of the exemplary viscous fluid collection device 100 is at a lower temperature than the collected fluid. Further, the portion 110 of the exemplary viscous fluid collection device 100 may be externally cooled (e.g., using airflow, a fan, thermal bath or other thermal transfer device) to a temperature below that of the collected fluid. Increasing the surface area of the portion 110 of the exemplary viscous fluid collection device 100 may also increase the amount of collected fluid exposed to the surface area of the portion 110 of the exemplary viscous fluid collection device 100 and, therefore, enhance the cooling of the collected fluid.

The features 10 or other aspects may include the same or similar materials as other sections of the portion 110 of the exemplary viscous fluid collection device 100. In addition, the features 10 or other aspects may include a material that enhances heat dissipation and/or channels heat away from either the collected viscous fluid or from other portions of the exemplary viscous fluid collection device 100. For example, the features 10 or other aspects may comprise a thermally conductive material, such as a metal, metal alloy, or composite material, or combinations thereof. The features 10 may include fibers or other aspects that aid in the conduction or heat or thermal energy away from viscous fluid contained in the fluid collection device 100. The features 10 or other aspects may be cooled (e.g., using airflow, a fan, thermal bath or other thermal transfer mechanism) to a temperature below that of the collected fluid. It may, for example, be advantageous for the features 10 or other aspects to thermally communicate (e.g., via thermally conductive channels) to draw thermal energy from the features either to another portion of the exemplary viscous fluid collection device 100, to an external reservoir (not shown), or simply away from the exemplary viscous fluid collection device 100.

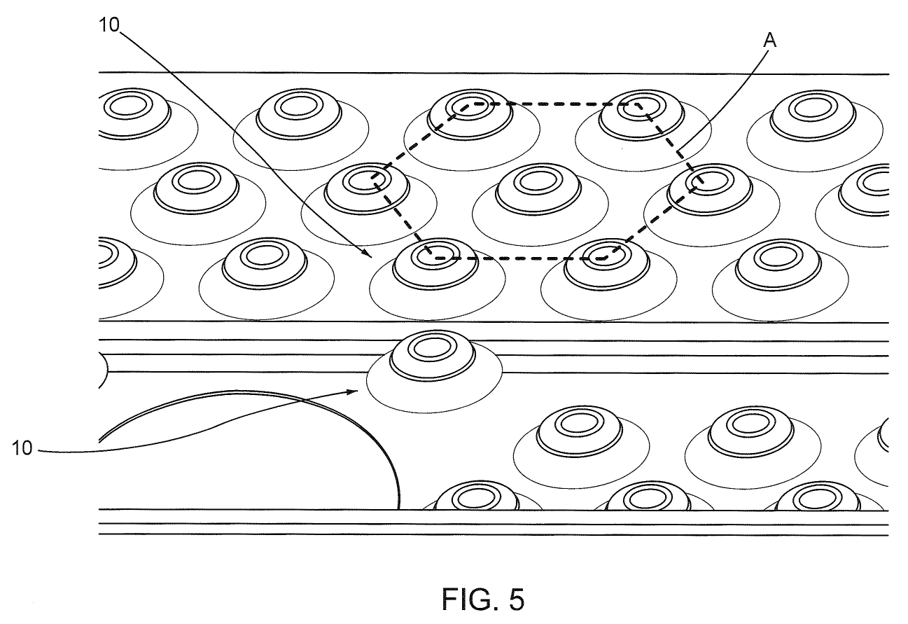

FIG. 5 is another close-up view of the bottom cavity surface of the exemplary viscous fluid collection device of FIG. 1A highlighting an exemplary hexagonal pattern of certain features. As shown in FIG. 5, the features 10 may be arranged in a hexagonal pattern A on the portion 110 of the exemplary viscous fluid collection device 100. Such a pattern may maximize the number of features 10 that can fit on the portion 110 of the exemplary viscous fluid collection device 100. It can be advantageous to increase the number of features 10 in order to, for example, increase both the surface area of the exemplary viscous fluid collection device 100 and/or increase the cooling effects associated with the features 10 discussed above. However, for certain applications, other arrangements of the features 10 may be advantageous. For example, it may be advantageous to arrange the features 10, such that their density increases in the direction away from side portions 120. Such a configuration may avoid pooling where the side portions 120 meet the bottom portion 110, among other things. It also may be advantageous, in certain variations, to provide a rectilinear or other pattern of features 10, in order to, for example, cover the portion 110. Other suitable patterns of features 10 may also be provided. It is to be understood that any suitable pattern of features is within the scope hereof.

The side portions 120 of the exemplary viscous fluid collection device 100 may be rectilinear, as shown in FIG. 1A, or they may have one of a number of other suitable shapes. For example, one or more of the side portions 120 may be bowed or convex, as in the variation 200 of FIG. 1C and variation 300 of FIG. 1D, in order to, among other things, accommodate more collected fluid. Alternatively, as shown in the variation 400 in FIG. 1E, one or more of the side portions 120 may be concave in order to, among other things, decrease the amount of space or volume taken up by the exemplary viscous fluid collection device 100. In addition, the side portions 120 may further include convex or concave sub-portions 20-22. The convex or concave sub-portions 20-22 may also be designed for fitting a particular apparatus or device from which fluid is to be extracted. For example, the convex or concave sub-portions 20-22 may be designed to fit to or around a particular type of engine or other fluid containing device. The convex or concave sub-portions 20-22 may, for example, provide finger grips or handles 20a (FIG. 1A) that may be used in the carrying or transporting of the exemplary viscous fluid collection device 100. The convex or concave sub-portions 20-22 may also provide grips or handles that may be used by a mechanical apparatus to move the exemplary viscous fluid collection device 100. In addition, the side portions 120 may include one or more bends 30 that may, for example, be designed to fit to or around a particular type of feature or other fluid containing device. The convex or concave sub-portions 20-22 may thereby allow a user to curl fingers underneath the handle and more easily lift the exemplary viscous fluid collection device 100 so that it can be transported to other location (e.g., from the device from which fluid is collected to a disposal location for the fluid).

Other aspects of the side portions 120, such as embossed, raised or lowered portions 21 and 22 shown in FIG. 1A, may serve to accommodate portions of the device from which fluid is collected and/or communicates with other devices (e.g., pumps, thermometer, volume meters, fans and fluid circulation devices). In addition, sloped sidewalls, such as sidewall 30, may be included in such side portions 120 in order to increase the surface area of the exemplary viscous fluid collection device 100 or for accommodating portions of the device from which fluid is collected and/or other devices (e.g., pumps, thermometer, volume meters, fans and fluid circulation devices).

FIG. 2 also shows a depression 31 in the bottom portion 110 of the exemplary viscous fluid collection device 100. The depression 31 may be included, for example, to increase the overall surface area of the portion 110 of the exemplary viscous fluid collection device 100. Alternatively, for example, the depression 31 may serve to accommodate portions of the device from which fluid is collected and/or accommodate other devices (e.g., pumps, thermometer, volume meters, fans and fluid circulation devices). In addition or alternative to these variations, the depression 31 may also include clear or transparent portions that act as windows so that the collected fluid may be observed by the user. The depression 31 may further include metrics, such as volume marks or other indicators that aid the user in ascertaining a property of the collected fluid. The depression 31 may also include stamped or otherwise imprinted symbols or text providing information to the user, such as instructions for using the exemplary viscous fluid collection device 100, safety warnings, etc. The stamped or otherwise imprinted symbols or text may also include make or model compatibility information or information relating to the manufacture of the device, for example.

The flange 130 may include a flat surface or a surface otherwise shaped and/or sized to fit an engine or other fluid using device. The flange 130 may also include a groove 130a and/or other features for maintaining a seal between the exemplary viscous fluid collection device 100 an engine or other fluid using device, directing fluid, or for one of a number of other suitable purposes. For example, the groove 130a may include features for retaining a pliable mating material, such as paperboard, cork, rubber, flexible plastic, fabric or combination of these and other suitable materials to create a fluid-tight seal when the flange 130 is pressed against a flat or other surface. The flange 130 may also include one or more openings 130b that may, for example, accommodate bolts, pins or other components capable of fixing the exemplary viscous fluid collection device 100 to another device or surface so that, among other things, the device 100 may collect fluid with decreased leakage or fluid loss. Bolts or other fixing or binding members may be inserted into the openings 130b so that the collection device 100 may be bolted, fixed or secured directly to an engine or other fluid containing device. In addition, it may also be possible to use the openings 130b to affix other components, such as pumps, fans or other cooling devices. For example, in one configuration a fan is affixed or otherwise secured to the flange 130 of the exemplary viscous fluid collection device 100, such as by using bolts placed through the openings 130b of the flange 130. The fan may then cool the exemplary viscous fluid collection device 100 itself or cool fluid in the exemplary viscous fluid collection device 100 once it has been collected from an engine or other fluid containing device. Still other devices may be affixed to the flange 130 via openings 130b. For example, diagnostic equipment, such as meters for indicating properties of the collected fluid (e.g., the depth, volume, viscosity, chemical composition or temperature of the collected fluid) may be affixed to the flange 130 using bolts or other fixing members.

Although the invention has been described with reference to various aspects of the present invention and examples with respect to a collecting fluid from an engine, it is within the scope and spirit of the invention to incorporate or be used in conjunction with any suitable device. Further, while the invention has been describe with reference to engine oil collection, the invention may be used with other applications, depending on circumstances in which the invention is used. Thus, it should be understood that numerous and various modifications may be made without departing from the spirit of the invention.

What is claimed is:

1. A viscous fluid collection device for collecting viscous fluid, including:
an interior cavity where the fluid is collected;
a bottom cavity surface, having an exterior facing side and an interior cavity facing side, wherein viscous fluid is collected on the interior cavity facing side;
one or more side portions contiguous with the bottom cavity surface, each of the side portions having an exterior facing side and an interior cavity facing side;
a flange connected to at least one of the side portions for closeably attaching the cavity of the viscous fluid collection device; and
interior or exterior features on at least one of the bottom cavity surface or one of the one or more side portions that increase surface area for the fluid collecting device in communication with collected fluid, the interior or exterior features being configured so as to increase heat dissipation and so as to be in thermal communication with the collected fluid.

2. The viscous fluid collection device of claim 1, wherein the viscous fluid is at least one selected from a group consisting of oil, transmission fluid and lubricant.

3. The viscous fluid collection device of claim 1, wherein the viscous fluid collection device comprises an oil pan closeably attached to a portion of an engine via contact of the flange with the portion.

4. The viscous fluid collection device of claim 1, wherein at least a portion of the interior or exterior features is located on the interior cavity facing side of the bottom cavity surface.

5. The viscous fluid collection device of claim 4, wherein the bottom cavity surface is divided into sections, such that at least two of the sections are not co-planar.

6. The viscous fluid collection device of claim 5, wherein the sections are staggered with respect to one another to steppably increase surface area for the fluid collecting device in communication with collected fluid.

7. The viscous fluid collection device of claim 4, wherein at least a portion the interior or exterior features occurs in a pattern that covers a portion of the interior cavity facing side of the bottom cavity surface.

8. The viscous fluid collection device of claim 1, wherein at least a portion of the interior or exterior features include one or more troughs for collecting viscous fluid.

9. The viscous fluid collection device of claim 1, wherein at least a portion of the features has a conical shape that includes a rounded apex, such that the surface area of the fluid collecting device in communication with collected fluid is increased.

10. The viscous fluid collection device of claim 1, wherein at least a portion of the interior or exterior features have a cross-section in at least one of a fin, block, pin and T-shape.

11. A viscous fluid collection device for collecting viscous fluid, including:
an interior cavity where the fluid is collected;
a bottom cavity surface, having an exterior facing side and an interior cavity facing side;
a pattern of features on the interior or exterior side of the bottom cavity surface, wherein the features in the pattern protrude into the interior or exterior of the viscous fluid collection device from the interior or exterior side of the bottom cavity surface and increase surface area for the fluid collecting device contacting collected fluid, the interior or exterior features being located so that they are thereby in thermal communication with the collected fluid;
one or more side portions on the bottom cavity surface, each of the side portions having an exterior facing side and an interior cavity facing side; and
a flange connected to at least one of the side portions for closeably attaching the cavity of the viscous fluid collection device.

12. The viscous fluid collection device of claim 11, wherein the viscous fluid is at least one selected from a group consisting of oil, transmission fluid and lubricant.

13. The viscous fluid collection device of claim 11, wherein the viscous fluid collection device comprises an oil pan closeably attached to a portion of an engine via contact of the flange with the portion.

14. The viscous fluid collection device of claim 11, wherein there are additional features that protrude into the interior of the viscous fluid collection device and increase surface area for the fluid collecting device in communication with collected fluid, the additional features being located on an interior cavity facing side of a side portion.

15. The viscous fluid collection device of claim 14, wherein the bottom cavity surface is divided into sections, such that at least two of the sections are not co-planar.

16. The viscous fluid collection device of claim 15, wherein the sections are staggered with respect to one another to steppably increase surface area for the fluid collecting device in communication with collected fluid.

17. The viscous fluid collection device of claim 11, wherein at least a portion of the features includes one or more troughs for collecting viscous fluid.

18. The viscous fluid collection device of claim 11, wherein at least a portion of the features has a conical shape that includes a rounded apex, such that the surface area of the fluid collecting device in communication with collected fluid is increased.

19. The viscous fluid collection device of claim 11, wherein at least a portion of the interior or exterior features have a cross-section in at least one of a fin, block, pin and T-shape.

20. A method of collecting viscous fluid in a device including:
collecting the viscous fluid in an interior cavity of a viscous fluid collection device; and
exposing the collected viscous fluid to features protruding from interior walls of the viscous fluid collection device that increase an interior and/or exterior surface area of the viscous fluid collection device, thereby conducting heat away from the collected fluid through the features.
